(19) United States
(12) Patent Application Publication
(10) Pub. No.: US 2011/0101572 A1
(43) Pub. Date: May 5, 2011

(54) METHOD OF MANUFACTURING CHARGING ROLLER FOR ELECTROPHOTOGRAPHIC IMAGE FORMING APPARATUS, AND CHARGING ROLLER MANUFACTURED BY THE SAME METHOD

(75) Inventors: Tae-hyun KIM, Hwaseong-si (KR); Jong-moon Eun, Seoul (KR); Yong-hoon Lee, Yongin-si (KR)

(73) Assignee: Samsung Electronics Co., Ltd, Suwon-si (KR)

(21) Appl. No.: 12/832,404

(22) Filed: Jul. 8, 2010

(30) Foreign Application Priority Data
Nov. 3, 2009 (KR) 2009-105414

(51) Int. Cl. B29C 47/88

(52) U.S. Cl. 264/470

(57) ABSTRACT

Disclosed is a method of manufacturing a charging roller useable in an electrophotographic image forming apparatus and a charging roller manufactured according to the method. The method includes introducing a conductive agent and a mixture of a rubber-based material and polyolefin-based resin into an extruder, extruding the conductive agent and the mixture to obtain an extrudate, crosslinking the extrudate by electron beam irradiation, and polishing the crosslinked extrudate. The method results in an environmentally friendly and simplified manufacturing processes, and/or in the reduction of the manufacturing costs.

### CROSS-REFERENCE TO RELATED APPLICATIONS

This application claims the benefit under 35 U.S.C. §119 (a) of Korean Patent Application No. 10-2009-0105414, filed on Nov. 3, 2009, in the Korean Intellectual Property Office, the entire disclosure of which is hereby incorporated by reference in its entirety.

### BACKGROUND

1. Field of the Invention

The present disclosure relates generally to a method of manufacturing a charging roller for an electrophotographic image forming apparatus and to a charging roller manufactured by the same method.

2. Description of the Related Art

Examples of electrophotographic image forming apparatuses may include, laser printers, facsimile machines, copiers, or the like. Such an electrophotographic image forming apparatus generally includes a photoconductive medium and a charging roller, a developing roller and a transferring roller, each arranged adjacent the photoconductive medium, for forming a predetermined image on a printing medium.

By way of an illustrative example, the surface of the photoconductive medium charged using the charging roller to a predetermined uniform electrical potential or voltage, and is then exposed to a light scanned by an exposing unit, resulting in the formation of an electrostatic latent image corresponding to the desired image on the surface of the photoconductive medium. The developing roller is then used to supply developer to the photoconductive medium so as to develop the electrostatic latent image into a developer image. The developer image is then transferred by the transferring roller to the printing medium passing between the photoconductive medium and the transferring roller.

In operation, the charging roller makes a contact with the photoconductive medium, and may desirably have a low hardness or rigidity in order to provide a uniform contact between the charging roller and the photoconductive medium. If the charging roller has an excessively high hardness and/or rigidity, the contact between the charging roller and the photoconductive medium may become uneven, potentially resulting in a defective, i.e., non-uniform, charging of the surface of the photoconductive medium, which in turn may result in image defects. Accordingly, to reduce the occurrences of defective charging, the hardness of an elastic layer of the charging roller is desirably sufficiently low, such as, for example, less than or equal to 80° when being measured by an A-type ASKER durometers.

Conventional multi-layered charging roller has an inner layer formed of a rubber material with low hardness and an external layer formed of an olefin-based heat shrink tube, so as to address the above described hardness characteristics. However, manufacturing of such conventional multi-layered charging roller involves complicated processes and relatively high manufacturing costs. An improved process of manufacturing a charging roller is thus desired.

### SUMMARY

One or more aspects of the present disclosure provide a method of manufacturing a charging roller, which simplifies the manufacturing processes, reduces manufacturing costs, and/or in which little or no defective charging between a photoconductive drum and a charging roller and little or no image defect occur.

According to an aspect of the present disclosure, a method of manufacturing a charging roller for an electrophotographic image forming apparatus is provided. The method may include the steps of introducing a conductive agent and a mixture of a rubber-based material and polyolefin-based resin into an extruder, extruding the conductive agent and the mixture to obtain an extrudate, crosslinking the extrudate by electron beam irradiation, and polishing the crosslinked extrudate.

The rubber-based material may comprise one selected from the group consisting of an acrylonitrile butadiene rubber, an epichlorohydrin rubber and a styrene butadiene rubber, and any mixture of two or more of the above listed materials. The polyolefin-based resin may comprise one selected from the group consisting of polypropylene, polyethylene and ethylene vinyl acetate copolymer, and any mixture of two or more of the above listed materials.

When the rubber-based material is an acrylonitrile butadiene rubber and the polyolefin-based resin is an ethylene vinyl acetate copolymer, a content ratio of the acrylonitrile butadiene rubber to the ethylene vinyl acetate copolymer may be in the range of about 3:7 to about 8:2.

Additionally, when the rubber-based material is an epichlorohydrin rubber and the polyolefin-based resin is an ethylene vinyl acetate copolymer, a content ratio of the epichlorohydrin rubber to the ethylene vinyl acetate copolymer may be in the range of about 3:7 to about 7:3.

The conductive agent may comprise one selected from the group consisting of a cationic surfactant such as lauryl trimethyl ammonium, stearyl trimethyl ammonium, octadodecyl trimethyl ammonium, dodecyl trimethyl ammonium, hexadecyl trimethyl ammonium, and modified fatty acid dimethyl ethyl ammonium; an anionic surfactant such as aliphatic sulfonate, higher alcohol sulfate ester salts, higher alcohol ethylene oxide-added sulfate ester salts, higher alcohol phosphate ester salts and higher alcohol ethylene oxide-added phosphate ester salts; a conductive carbon black; metal oxide such as tin oxide, titanium oxide, lithium oxide and zinc oxide; metals such as nickel, cooper, lithium, silver, and germanium; metal salts such as LiCF₃SO₃, NaClO₄, LiAsF₆, LiBF₄, NaSCN, KSCN, and NaCl; a conductive polymer such as polyaniline, polypyrrole, and polyacetal; and any mixture of the above listed materials.

The conductive agent may be contained in an amount within a range from about 1 phr to about 20 phr.

The method may further comprise, before the crosslinking and the polishing, expanding the extrudate and contracting the expanded extrudate.

The method may further comprise, after the polishing, washing the polished extrudate.

The crosslinking may comprise irradiating the electron beam onto the extrudate in a radiation shielding chamber.

The charging roller manufactured using the method may have a single-layered structure.

According to another aspect of the present disclosure, a charging roller useable in an electrophotographic image forming apparatus may be manufactured by introducing a conductive agent and a mixture of a rubber-based material and polyolefin-based resin into an extruder, extruding the conductive agent and the mixture to obtain an extrudate, crosslinking the extrudate by electron beam irradiation, and by polishing the crosslinked extrudate.

According to yet another aspect of the present disclosure, an electrophotographic image forming apparatus may be provided to include a charging roller having a single-layered roller structure formed of an crosslinked mixture of a conductive agent, a rubber-based material and polyolefin-based resin.

The electrophotographic image forming apparatus may further include a photoconductor having a photoconductive surface, a charging roller configured to electrically charge the photoconductive surface of the photoconductor, an exposure unit configured to irradiate light on the charged photoconductive surface of the photoconductor so as to form thereon an electrostatic latent image, a toner carrier configured to apply toner to the photoconductive surface of the photoconductor so as to develop the electrostatic latent image into a toner image and a transferring roller configured to transfer the toner image from the photoconductive surface of the photoconductor onto a sheet of paper.

### BRIEF DESCRIPTION OF THE DRAWINGS

Various features and advantages of the disclosure will become more apparent by the following detailed description of several embodiments thereof with reference to the attached drawings, of which:

FIG. 1 is a view illustrating an image forming apparatus having a charging roller according to an embodiment of the present disclosure;

FIG. 2A is a perspective view illustrating a charging roller manufactured according to an embodiment of the present disclosure;

FIG. 2B is a sectional view of the charging roller shown in FIG. 2A; and

FIG. 3 is a flowchart illustrating a method of manufacturing a charging roller according to an embodiment.

### DETAILED DESCRIPTION OF THE EMBODIMENTS

Reference will now be made in detail to embodiments of the present invention, examples of which are illustrated in the accompanying drawings, wherein like reference numerals refer to like elements. While the embodiments are described with detailed construction and elements to assist in a comprehensive understanding of the various applications and advantages of the embodiments, it should be apparent however that the embodiments can be carried out without those specifically detailed particulars. Also, well-known functions or constructions will not be described in detail so as to avoid obscuring the description with unnecessary detail. It should be also noted that in the drawings, the dimensions of the features are not intended to be to true scale and may be exaggerated for the sake of allowing greater understanding.

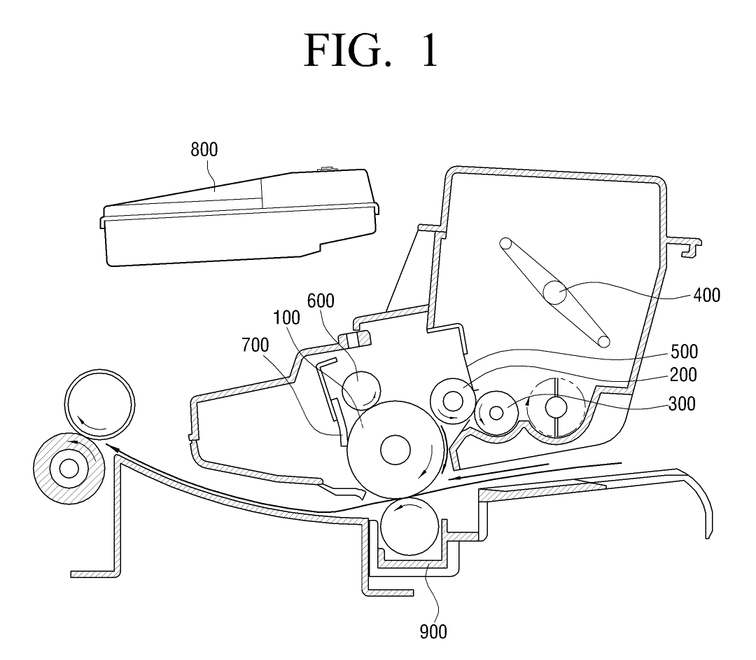

FIG. 1 provides a view of an electrophotographic image forming apparatus having a charging roller according to an embodiment of the present disclosure. Referring to FIG. 1, a photoconductor 100 has a photoconductive surface capable of being charged to, and to hold, a predetermined electrical potential, and on which an electrostatic latent image can be formed by discharging in selective portions thereof in response to an exposure to light. Developer such as, for example, toner, can selectively be attached to the photoconductive surface according to the electrostatic latent image during the developing process. A toner carrier 200 is configured to carry the toner onto the photoconductive surface using, in part, the difference between the respective velocities of a supplying roller 300 and the toner carrier 200. A toner layer regulating device 500 may be provided to regulate the amount of the toner being carried on the surface of the toner carrier 200. The supplying roller 300 may be configured to supply the toner to the toner carrier 200 using, in part, the relative difference in velocity with the toner carrier 200, which may further aide in realizing sufficient uniformity in the amount of, and/or the level of charge held by, the toner carried by the toner carrier 200 even when an uneven amount, and/or charge, of the toner may be attached to the supplying roller 300 itself. To that end, the supplying roller 300 may be manufactured using a semi-conductive foamable material. The toner may be a the developer that is consumed for the developing operations, and may include a resin as one of its main raw material. The developer agitator 400 may be configured to rotate, stirring or agitating, the developer so as to prevent the formation of lumps of developer and/or to cause electrically charging of the developer.

A charging roller 600 may be configured to electrically charge the surface of the photoconductor 100, and may be, for example, a roller type of a corona type charging device. A cleaning blade 700 may be made of a sheet material, such as a urethane rubber or the like, in order to remove the residual toner remaining on the photoconductor 100 after the transferring of the developer image onto a printing medium. A laser scanning unit (LSU) 800 may be configured to irradiate light onto the charged surface of the photoconductor 100 to form an electrostatic latent image on the surface of the photoconductor 100 using, for example, a laser diode as the light source. A transferring roller 900 may be configured to apply an electrical potential having a polarity opposite to that of toner so as to cause the movement of the toner, which is attached to the photoconductor 100 with a relatively weak attraction force of a potential difference on the surface of the photoconductor 100, onto the printing medium, e.g., a sheet of paper.

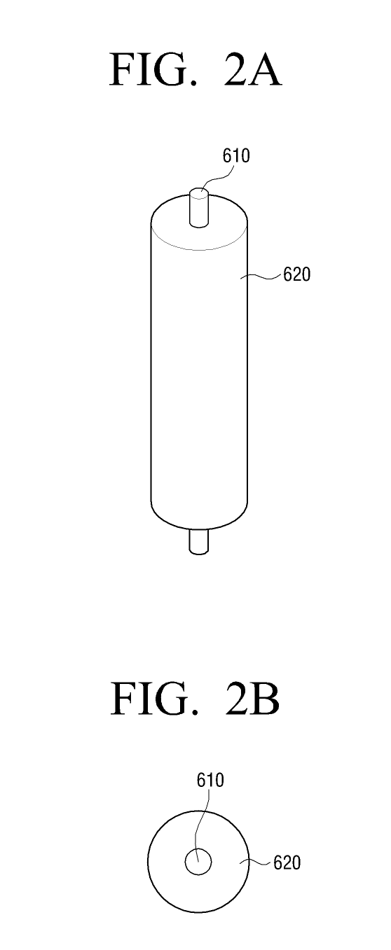

FIGS. 2A and 2B illustrate a charging roller manufactured according to an embodiment of the present disclosure. Referring to FIGS. 2A and 2B, a single-layered charging roller is provided with a metal shaft 610 disposed on the center thereof and an elastic member 620 enclosing a portion of the metal shaft 610.

To manufacture the elastic member 620, conventionally, rubber-based raw materials and a vulcanizing agent are heated to a predetermined temperature for a predetermined period of time, so as to provide properties of a rubber roller. A rubber roller using the vulcanizing agent requires a device, such as a chamber and a boiler, to perform the heating to a predetermined temperature during the vulcanizing operation, and may require a long period of time for the vulcanizing operation in order to provide sufficiently stable properties. Thus, an increase in the production capacity of such rollers may be limited. In the case of a multi-layered roller, the vulcanizing agent may be applied partially to the base material or on an external layer so that a relatively lower manufacturing may be realized by consecutive manufacturing steps. However, there may be limits to the reduction of the manufacturing costs for a single-layered charging roller in comparison to the manufacturing of a multi-layered charging roller.

Additionally, a polyolefin-based resin may be used to manufacture an elastic member of a charging roller. However, since the hardness of the polyolefin-based resin may be too high for use as a charging member of a single-layered structure, it is difficult to ensure not only charge uniformity, but also mass productivity and reliance. Thus, the polyolefin-based resin has not been widely used in practice.

One or more aspects of the present disclosure provides a method of manufacturing a semiconductive charging roller using a heat shrink tube, and that can be manufactured in sequential processing steps, and provides, in particular, a method of manufacturing a semiconductive charging roller with a single-layered structure.

According to an embodiment, the heat shrink tube may be a polyolefin resin, such as polypropylene, polyethylene, or ethylene vinyl acetate copolymer. While the polyolefin resin may advantageously be crosslinked with relative ease by light irradiation, due to the fact that the polyolefin resin has a hardness of 80° or greater, it may not be desirable to use the polyolefin resin alone to manufacture a charging roller.

Generally, a multi-layered charging roller is manufactured by forming an inner layer of a rubber elastic body with low hardness, and by forming an external layer of an olefin-based heat shrink tube. However, such a multi-layered structure may increase the manufacturing costs.

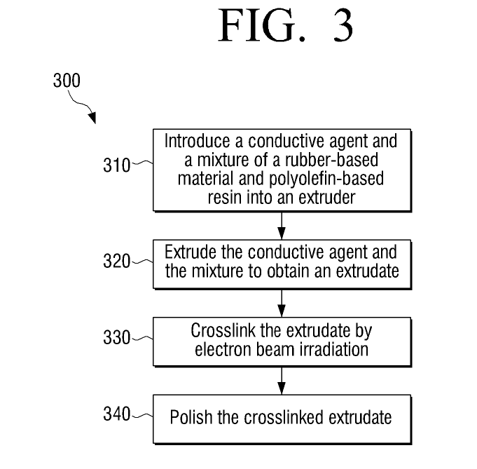

With reference to FIG. 3, a method 300 of manufacturing a charging roller according to an embodiment of the present disclosure is illustrated. At 310, a conductive agent and a mixture of a rubber-based material and polyolefin-based resin are introduced into an extruder. At 320, the conductive agent and the mixture are extruded to obtain an extrudate. At 330, the extrudate is crosslinked by electron beam irradiation, and, at 340, the crosslinked extrudate is polished.

The rubber-based material may be one selected from the group including, for example, without limitation, an acrylonitrile butadiene rubber, an epichlorohydrin rubber and a styrene butadiene rubber, or a mixture of two or more of the above listed materials. The rubber-based material however is not limited to the above materials. For example, silicon rubber, ethylene-propylene-diene rubber, or the like can also be used as a rubber-based material.

Epichlorohydrin rubber can be, but is not limited to, a ternary copolymer of ethylene oxide, arylglycidylether and epichlorohydrine, or a binary copolymer of ethylene oxide and epichlorohydrin. If an ethylene oxide copolymer is used as an epichlorohydrin rubber, a ratio of the ethylene oxide copolymer may desirably be greater than at least 30 mol %, and most desirably in the range of about 30 mol % to about 70 mol %. If the ratio of the ethylene oxide copolymer is less than 30 mol %, it may be difficult to obtain the resistance values suitable for use as the charging roller.

The acrylonitrile butadiene rubber refers to a copolymer prepared by emulsion polymerization of acrylonitrile and butadiene at a low temperature and that is effective in oil resistance and chemical resistance. As the acrylonitrile content increases, resin properties in the polymer become stronger, so that properties such as wear resistance, tensile strength or chemical resistance improves. On the other hand, rebound resilience, compression set, cold resistance or elongation may be reduced. The acrylonitrile content in the acrylonitrile butadiene rubber applicable to the embodiment of the present disclosure may desirably be in the range of about 5 mol % to about 40 mol %. If the acrylonitrile content exceeds 40 mol %, the acrylonitrile butadiene rubber may be increasingly dependent on the environmental conditions. Alternatively, if the acrylonitrile content is less than 5 mol %, the resistance of the acrylonitrile butadiene rubber may be increased, and thus it may be difficult to obtain desired resistance values suitable for the charging roller.

The polyolefin-based resin used in an embodiment of the present disclosure may be, but is not limited to, one selected from the group including polypropylene, polyethylene and an ethylene vinyl acetate copolymer, or a mixture of two or more of the above listed materials.

An ethylene vinyl acetate copolymer can be used as a resin, and various types of ethylene vinyl acetate copolymer are commercially available according to the content of vinyl acetate. The content of vinyl acetate in an ethylene vinyl acetate copolymer to be used according to an embodiment of the present disclosure may desirably be in the range of about 5% by weight to about 50% by weight. In this range, the ethylene vinyl acetate copolymer may have good processability. If however the content of vinyl acetate is less than 5% by weight, the hardness of the ethylene vinyl acetate copolymer may become excessively high, and accordingly it may be difficult to use the ethylene vinyl acetate copolymer in manufacturing of a charging roller. If the content of vinyl acetate exceeds 50% by weight, the ethylene vinyl acetate copolymer may have adhesiveness, i.e., may become sticky. When the adhesive ethylene vinyl acetate copolymer is used to manufacture a charging roller, the resulting charging roller may become prone to contamination, which may lead to image defects.

A conductive agent usable in the method of manufacturing a charging roller according to an embodiment of the present disclosure can be one selected from the group including a cationic surfactant such as lauryl trimethyl ammonium, stearyl trimethyl ammonium, octadodecyl trimethyl ammonium, dodecyl trimethyl ammonium, hexadecyl trimethyl ammonium, and modified fatty acid dimethyl ethyl ammonium; an anionic surfactant such as aliphatic sulfonate, higher alcohol sulfate ester salts, higher alcohol ethylene oxide-added sulfate ester salts, higher alcohol phosphate ester salts and higher alcohol ethylene oxide-added phosphate ester salts; a conductive carbon black; metal oxide such as tin oxide, titanium oxide, lithium oxide and zinc oxide; metals such as nickel, cooper, lithium, silver, and germanium; metal salts such as LiCF₃SO₃, NaClO₄, LiAsF₆, LiBF₄, NaSCN, KSCN, and NaCl; a conductive polymer such as polyaniline, polypyrrole, and polyacetal; or a mixture of the above listed materials.

Examples of a conductive carbon black used as a conductive agent may include Ketjenblack EC, acetylene black, carbon black for rubber use, oxidized ink carbon and thermal black. In more detail, a conductive carbon black can be, for example, carbon blacks for use in rubbers such as Super Abrasion Furnace (SAF) carbon black, Intermediate Super Abrasion Furnace (ISAF) carbon black, High Abrasion Furnace (HAF) carbon black, Fast Extruding Furnace (FEF) carbon black, General Purpose Furnace (GPF) carbon black, Semi Reinforcing Furnace (SRF) carbon black, Fine Thermal (FT) carbon black, and Medium Thermal (MT) carbon black. Graphite, such as natural graphite and artificial graphite, can alternatively be used as a conductive agent.

In the method of manufacturing the charging roller according to an embodiment of the present disclosure, calcium carbonate can be added as an additive in order to increase the hardness of an elastic member, for example, to improve the wear resistance. To improve dispersibility with a rubber material, activated calcium carbonate, of which a surface is treated with organic matters, can be used. To treat a surface of calcium carbonate, fatty acids, resin acids or surfactants can be used.

Available calcium carbonate may desirably have an average particle size in the range of about 0.01 microns (μm) to about 50 μm. If an average particle size of calcium carbonate is less than 0.01 μm, workability may be reduced, and alternatively if an average particle size of calcium carbonate is greater than 50 μm, wear resistance may be reduced.

Calcium carbonate may desirably be blended in an amount of about 5 phr to about 80 phr based on 100 phr of rubber components. If calcium carbonate is blended in an amount less than 5 phr, the effect of wear resistance may be reduced, and alternatively if calcium carbonate is blended in an amount greater than 80 phr, workability may be reduced.

The method of manufacturing a charging roller according to an embodiment of the present disclosure can be performed through a simple process including mixing and extruding, crosslinking by electron beam irradiation, expanding, contracting, polishing, washing and UV radiation, instead of a conventional complicated process that may include the washing of a shaft, primer coating of a shaft, rubber mixing, extruding, primary curing, secondary curing, primary polishing, secondary polishing, side cutting, tertiary polishing, washing, UV radiation and tertiary vulcanizing.

According to an aspect of the present disclosure, the conventionally required three step curing process may be reduced to a single step of crosslinking by electron beam irradiation. More specifically, the primary curing and secondary curing take about 5 to 7 hours, whereas the crosslinking by electron beam irradiation takes a relatively short period of time because crosslinking is able to be performed at about 100 m per minute.

Additionally, when manufacturing a charging roller according to an embodiment of the present disclosure, there is no need to perform shaft primer coating and drying, and thus the method of manufacturing the charging roller can be simplified.

A conventional extruding operation creates a large outside diameter of a tube due to vibration. However, an electron beam irradiation system, according to an embodiment of the present disclosure, minimizes an outside diameter of a tube during extruding, and thus an amount of raw materials to be used may be reduced.

In addition, the three step polishing process is conventionally utilized to match the outside diameter and the runout, but the electron beam irradiation system according to an embodiment of the present disclosure may satisfy the outside diameter and runout requirement by the primary polishing only, thereby reducing the number of steps of the polishing process.

Furthermore, the price of resins is generally less than that of rubbers, and thus, in using the mixture of a rubber and a resin, a content ratio of a resin and a rubber having high efficiency may be selected, thereby making it possible to reduce the raw material costs.

In general, when a vulcanizing agent, such as sulfur, sulfur donor, organic peroxide, mercapto triazines and thiourea, is used, environmental pollution may occur. However, such a vulcanizing agent is not used in an embodiment of the present disclosure, thus providing an environmentally friendly manufacturing method.

Alternatively, a conventional charging roller can be manufactured by preparing a rubber tube and pressurizing a shaft into the rubber tube. In this situation, extruding rubbers or a mixture of rubbers and resins is performed by an extruder to obtain an extrudate in the form of a tube, and crosslinking is then performed by passing the extrudate through an oven at about 100° C. to about 200° C., thereby fabricating a rubber tube. However, this method has disadvantages in that it is difficult to form a rubber tube with a uniform thickness due to the difference in the degree of rubber crosslinking between the initial stage and the final stage during the tube withdrawal. Accordingly, a thick tube is typically formed, which results in an increase in the cost. Additionally, since an inside diameter of the tube is less than an outside diameter of the shaft, air is infused into the tube so that the shaft is pressurized into the tube. In this situation, it is easy to pressurize the shaft into the tube only when the tube has a low coefficient of friction, whereas it is difficult to insert the shaft into the tube due to rubber friction and since a surface of the tube becomes uneven when a tube is formed of an elastic body such as a rubber. This unevenness of the surface causes detective charging, thereby causing image defects.

However, these problems do not occur in the charging roller manufactured according to one or more embodiments of the present disclosure.

### EXAMPLES

Hereinafter, the present disclosure will be described in greater detail with reference to the following examples and comparative examples. The following examples are for illustrative purposes only and are not intended to limit the scope of the disclosure. Herein, the unit ‘phr’used as a content ratio means ‘part per hundred resin,’ which indicates parts by weight for each component with respect to 100 parts by weight of a resin.

### Example 1

In this example, 30 phr of an epichlorohydrin rubber (manufactured by Nippon Zeon Co. Ltd., grade: 3102), 70 phr of an ethylene vinyl acetate copolymer (manufactured by Hanwha Chemical Co., grade: 1315), 1 phr of carbon black (manufactured by Korea carbon black Co. Ltd., SRF), 20 phr of calcium carbonate, 3 phr of a conductive agent (lithium complex type, manufactured by Nano Chem-Tech, Inc.), 5 phr of ZnO, and 1 phr of stearic acid are mixed. The mixture is introduced into an extruder, and a tube is extruded with an inside diameter of 5.5 mm and an outside diameter of 13.0 mm. The extruded tube is then crosslinked through an electron beam accelerator (manufactured by EB tech Co., Ltd, ELV-8). The amount of electron beam to be irradiated to the chamber for shielding radiation is 12 Mrad. Herein, the unit ‘Mrad’ indicates an absorption energy amount of radiation, and is represented by ‘rd.’ 1 rd means an absorption amount measured when energy of 100 erg is given for each 1 g of material by ionic particles (x rays, secondary electrons in cases of γ rays, γ particles in cases of neutron rays just as in the secondary electrons, and protons etc.) or by irradiation.

Subsequently, the crosslinked extrudate is used to manufacture a tube with an inside diameter of 6.5 mm through an expander. The expanded tube is cut into 280 mm, and a 6.5 mm shaft is inserted into the cut tube. The tube into which the shaft is inserted is contracted in an oven for 1 hour at 150° C.

The contracted tube roller is polished using a polishing stone, and then a charging roller is accordingly manufactured.

### Example 2

In this example, a charging roller is manufactured in substantially the same manner as in Example 1, with the difference being that 50 phr of an epichlorohydrin rubber and 50 phr of an ethylene propylene copolymer are used to prepare the mixture.

### Example 3

In this example, a charging roller is manufactured in substantially the same manner as in Example 1, with the difference being that 70 phr of an epichlorohydrin rubber and 30 phr of an ethylene propylene copolymer are used to prepare the mixture.

### Example 4

In this example, 30 phr of an acrylonitrile butadiene rubber (manufactured by Nippon Zeon Co. Ltd., grade: DN 401 L), 70 phr of an ethylene vinyl acetate copolymer (manufactured by Hanwha Chemical Co., grade: 1315), 20 phr of carbon black (300J, manufactured by Lion Co., Ltd., furnace black), 20 phr of calcium carbonate, 5 phr of ZnO, and 1 phr of stearic acid are mixed. The mixture is introduced into an extruder, and a tube is extruded with an inside diameter of 5.5 mm and an outside diameter of 13.0 mm. The extruded tube is then crosslinked through an electron beam accelerator (manufactured by EB tech Co., Ltd, ELV-8). The amount of electron beam to be irradiated to the chamber for shielding radiation is 12 Mrad.

Subsequently, the crosslinked extrudate is used to manufacture a tube with an inside diameter of 6.5 mm through an expander. The expanded tube is cut into 280 mm, and a 6.0 mm shaft is inserted into the cut tube. The tube into which the shaft is inserted is contracted in an oven for 1 hour at 150° C.

The contracted tube roller is polished using a polishing stone, and then a charging roller is accordingly manufactured.

### Example 5

In this example, a charging roller is manufactured in substantially the same manner as in Example 4, with the difference being that 50 phr of an acrylonitrile butadiene rubber and 50 phr of an ethylene vinyl acetate copolymer are used to prepare the mixture.

### Example 6

In this example, a charging roller is manufactured in substantially the same manner as in Example 4, with the difference being that 70 phr of an acrylonitrile butadiene rubber and 30 phr of an ethylene vinyl acetate copolymer are used to prepare the mixture.

### Example 7

In this example, a charging roller is manufactured in substantially the same manner as in Example 4, with the difference being that 80 phr of an acrylonitrile butadiene rubber and 20 phr of an ethylene vinyl acetate copolymer are used to prepare the mixture.

### Example 8

In this example, a charging roller is manufactured in substantially the same manner as in Example 1, with the difference being that 1 phr of the conductive agent is used.

### Example 9

In this example, a charging roller is manufactured in substantially the same manner as in Example 1, with the difference being that 5 phr of the conductive agent is used.

### Example 10

In this example, a charging roller is manufactured in substantially the same manner as in Example 1, with the difference being that 10 phr of the conductive agent is used.

### Comparative Example 1

In this example, a charging roller is manufactured in substantially the same manner as in Example 1, with the difference being that 20 phr of an epichlorohydrin rubber and 80 phr of an ethylene propylene copolymer are used to prepare the mixture, 2 phr of peroxide is mixed with the mixture before the mixture is introduced into an extruder, and then extruding and crosslinking are performed without using an electron beam accelerator.

### Comparative Example 2

In this example, a charging roller is manufactured in substantially the same manner as in Example 1, with the difference being that 50 phr of an epichlorohydrin rubber and 50 phr of an ethylene propylene copolymer are used to prepare the mixture, 2 phr of peroxide is mixed with the mixture before the mixture is introduced into an extruder, and then extruding and crosslinking are performed without using an electron beam accelerator.

### Comparative Example 3

In this example, a charging roller is manufactured in substantially the same manner as in Example 1, with the difference being that 80 phr of an epichlorohydrin rubber and 20 phr of an ethylene propylene copolymer are used to prepare the mixture, 2 phr of peroxide is mixed with the mixture before the mixture is introduced into an extruder, and then extruding and crosslinking are performed without using an electron beam accelerator.

### Comparative Example 4

In this example, a charging roller is manufactured in substantially the same manner as in Example 1, with a difference being that 20 phr of an epichlorohydrin rubber and 80 phr of an ethylene propylene copolymer are used to prepare the mixture.

### Comparative Example 5

In this example, a charging roller is manufactured in substantially the same manner as in Example 1, with the difference being that 80 phr of an epichlorohydrin rubber and 20 phr of an ethylene propylene copolymer are used to prepare the mixture.

### Comparative Example 6

In this example, a charging roller is manufactured in substantially the same manner as in Example 4, with the difference being that 90 phr of an acrylonitrile butadiene rubber and 10 phr of an ethylene vinyl acetate copolymer are used to prepare the mixture.

### Comparative Example 7

In this example, a charging roller is manufactured in substantially the same manner as in Example 4, with the difference being that an acrylonitrile butadiene rubber is not used and instead 100 phr of an ethylene vinyl acetate copolymer only is used to prepare the mixture, 2 phr of peroxide is mixed with the mixture before the mixture is introduced into an extruder, and then extruding and crosslinking are performed without using an electron beam accelerator.

### Comparative Example 8

In this example, a charging roller is manufactured in substantially the same manner as in Example 4, with the difference being that 20 phr of an acrylonitrile butadiene rubber and 80 phr of an ethylene vinyl acetate copolymer are used to prepare the mixture.

### Comparative Example 9

In this example, a charging roller is manufactured in substantially the same manner as in Example 1, with the difference being that a conductive agent is not used.

### Comparative Example 10

In this example, a charging roller is manufactured in substantially the same manner as in Example 1, with the difference being that 0.5 phr of a conductive agent is used.

The content of components of the charging rollers manufactured in Examples 1 to 10 and Comparative Examples 1 to 10 is listed below in Table 1. In Table 1, the content of each component is represented by phr. ECO represents epichlorohydrin rubber, NBR represents an acrylonitrile butadiene rubber, and EVA represents an ethylene vinyl acetate copolymer. Additionally, the carbon black is divided into a general colorant, namely SRF, and a conductive furnace black.

TABLE 1

| | | | | | | | | | | | | Comp. | Comp. |
|---|---|---|---|---|---|---|---|---|---|---|---|---|---|
| Components | | Ex. 1 | Ex. 2 | Ex. 3 | Ex. 4 | Ex. 5 | Ex. 6 | Ex. 7 | Ex. 8 | Ex. 9 | Ex. 10 | Ex. 1 | Ex. 2 |
| Rubber | ECO | 30 | 50 | 70 | | | | | 30 | 30 | 30 | 20 | 50 |
| | NBR | | | | 30 | 50 | 70 | 80 | | | | | |
| EVA | | 70 | 50 | 30 | 70 | 50 | 30 | 20 | 70 | 70 | 70 | 80 | 50 |
| Carbon | SRF | 1 | 1 | 1 | | | | | 1 | 1 | 1 | 1 | 1 |
| Black | Furnace | | | | 20 | 20 | 20 | 20 | | | | | |
| | Black | | | | | | | | | | | | |

| | | | | | | | | | | | | |
|---|---|---|---|---|---|---|---|---|---|---|---|---|
| Peroxide | — | — | — | — | — | — | — | — | — | — | 2 | 2 |
| Calcium carbonate | 20 | 20 | 20 | 20 | 20 | 20 | 20 | 20 | 20 | 20 | 20 | 20 |
| Conductive agent | 3 | 3 | 3 | — | — | — | — | 1 | 5 | 10 | 3 | 3 |
| ZnO | 5 | 5 | 5 | 5 | 5 | 5 | 5 | 5 | 5 | 5 | 5 | 5 |
| Stearic acid | 1 | 1 | 1 | 1 | 1 | 1 | 1 | 1 | 1 | 1 | 1 | 1 |

| | | Comp. | Comp. | Comp. | Comp. | Comp. | Comp. | Comp. | Comp. |
|---|---|---|---|---|---|---|---|---|---|
| Components | | Ex. 3 | Ex. 4 | Ex. 5 | Ex. 6 | Ex. 7 | Ex. 8 | Ex. 9 | Ex. 10 |
| Rubber | ECO | 80 | 20 | 80 | | | | 30 | 30 |
| | NBR | | | | 90 | 0 | 20 | | |
| EVA | | 20 | 80 | 20 | 10 | 100 | 80 | 70 | 70 |
| Carbon | SRF | 1 | 1 | 1 | | | | 1 | 1 |
| Black | Furnace | | | | 20 | 20 | 20 | | |
| | Black | | | | | | | | |

| | | | | | | | | |
|---|---|---|---|---|---|---|---|---|
| Peroxide | 2 | 4 | — | — | 2 | — | — | — |
| Calcium carbonate | 20 | 20 | 20 | 20 | 20 | 20 | 20 | 20 |
| Conductive agent | 3 | 3 | 3 | — | — | — | 0 | 0.5 |
| ZnO | 5 | 5 | 5 | 5 | 5 | 5 | 5 | 5 |
| Stearic acid | 1 | 1 | 1 | 1 | 1 | 1 | 1 | 1 |

### Testing Results

Test for Resistance.

Resistance of each of the charging rollers manufactured in Examples 1 to 10 and Comparative Examples 1 to 10 is measured. The resistance is measured by applying −500 V of voltage to the charging roller and reading the current value. Resistance values are obtained by the following equation:

R(resistance)=V(voltage)/I(current).

Test for Hardness.

Hardness of each of the charging rollers manufactured in Examples 1 to 10 and Comparative Examples 1 to 10 is measured using an ASKER A-type durometer.

Test for Degree of Crosslinking.

The degree of crosslinking is measured as gel fraction using a soxylet apparatus. More specifically, about 5 g of an elastic body of the charging roller is inserted into the soxylet apparatus, and a xylene solvent is circulated. In such situation, the non-crosslinked portion is melted in the solvent. After 24 hours, the rubber is dried in an oven, and then the change in the weight of the rubber after drying is measured. Subsequently, the degree of crosslinking is measured using the following equation:

Degree of crosslinking(%)=(1−((initial weight of rubber−weight of rubber changed after 24 hours)/initial weight of rubber))×100

Test for Defective Charging.

Defective charging refers to the phenomenon where a black band occurs for a rotation cycle of a charging roller mounted in a developing apparatus during image printing. After the manufactured charging rollers are mounted in the developing apparatus, an image is printed, and occurrence of black bands is observed.

Test Under High Temperature/High Humidity.

This test is performed to evaluate whether image defects occur due to environmental conditions. In more detail, a charging roller mounted in a toner cartridge is left in an oven for seven days, and then an image is printed using the charging roller, so as to detect occurrence or non-occurrence of image defects.

During the seven day period, the charging roller is left in an atmosphere of 25° C. and 55% for 1 day, in an atmosphere of 40° C. and 90% for 1.5 days, in an atmosphere of 50° C. and 80% for 2 days, in an atmosphere of 40° C. and 90% for 1.5 days, and then in an atmosphere of 25° C. and 55% for 1 day, sequentially.

Table 2 shows the test results for the charging rollers manufactured according to Examples 1 to 10. In Table 2, the unit of resistance is Ohms, abbreviated as Ω, and the degree of crosslinking is represented by percentage (%). In the test results, ‘o’ represents good, ‘ ’ represents ordinary, and ‘x’ represents poor.

TABLE 2

| | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|
| Resistance | 5.0 × 10⁷ | 1.0 × 10⁶ | 4.0 × 10⁵ | 4.0 × 10⁵ | 3.0 × 10⁵ | 2.0 × 10⁵ | 1.0 × 10⁵ | 2.0 × 10⁷ | 4.0 × 10⁶ | 9.0 × 10⁵ |
| Hardness | 72 | 60 | 48 | 76 | 61 | 50 | 47 | 73 | 72 | 72 |
| Degree of | 96 | 93 | 90 | 94 | 91 | 90 | 80 | 96 | 96 | 96 |
| Crosslinking | | | | | | | | | | |
| Defective | Δ | ∘ | ∘ | ∘ | ∘ | ∘ | ∘ | Δ | ∘ | ∘ |
| charging | | | | | | | | | | |
| High | ∘ | ∘ | Δ | ∘ | ∘ | ∘ | ∘ | ∘ | ∘ | Δ |
| temperature | | | | | | | | | | |
| and high | | | | | | | | | | |
| humidity | | | | | | | | | | |

Table 3 shows the test results for the charging rollers manufactured according to Comparative Examples 1 to 10. The unit of each test value is the same as described above for Table. 2.

TABLE 3

| | Comp. | Comp. | Comp. | Comp. | Comp. | Comp. | Comp. | Comp. | Comp. | Comp. |
|---|---|---|---|---|---|---|---|---|---|---|
| | Ex. 1 | Ex. 2 | Ex. 3 | Ex. 4 | Ex. 5 | Ex. 6 | Ex. 7 | Ex. 8 | Ex. 9 | Ex. 10 |
| Resistance | 3.0 × 10⁹ | 1.0 × 10⁶ | 3.0 × 10⁵ | 3.0 × 10⁹ | 3.0 × 10⁵ | 1.0 × 10⁵ | 4.0 × 10⁵ | 4.0 × 10⁵ | 9.0 × 10⁹ | 9.0 × 10⁸ |
| Hardness | 82 | 61 | 43 | 81 | 43 | 96 | 96 | 84 | 72 | 73 |
| Degree of | 95 | 94 | 85 | 96 | 78 | 65 | 96 | 95 | 96 | 96 |
| Crosslinking | | | | | | | | | | |
| Defective | X | ∘ | ∘ | x | ∘ | ∘ | x | x | x | x |
| charging | | | | | | | | | | |
| High | ∘ | ∘ | X | ∘ | x | x | ∘ | ∘ | ∘ | Δ |
| temperature | | | | | | | | | | |
| and high | | | | | | | | | | |
| humidity | | | | | | | | | | |

When manufacturing the charging rollers according to Examples 1 to 10 and Comparative Examples 4, 5, 6, 8, 9 and 10, crosslinking was performed by electron beam irradiation without adding peroxide, namely a crosslinking agent. All the charging rollers manufactured through the crosslinking operation by electron beam irradiation, except for the charging roller in Comparative Example 5, are no less effective in degree of crosslinking than the charging rollers manufactured using the crosslinking agent. Referring to Tables 2 and 3, the charging rollers in Examples 1 to 10 and Comparative Examples 4 and 6 to 10 have degree of crosslinking of 80% or higher.

In the charging rollers manufactured according to Examples 1 to 3, content ratios of the epichlorohydrin rubber to the ethylene vinyl acetate copolymer are 3:7, 5:5 and 7:3, respectively. No defective charging, nor an image defect, were seen in the test for defective charging and the test under high temperature/high humidity for the charging rollers.

However, in the charging rollers manufactured according to Comparative Examples 1 and 4 in which the content ratio of the epichlorohydrin rubber to the ethylene vinyl acetate copolymer is 2:8, defective charging occurred regardless of the addition of peroxide.

This defective charging is related to the hardness. When the ethylene vinyl acetate copolymer is contained in an amount of 80 phr or greater, for example when charging rollers are manufactured according to Comparative Examples 1 and 4, the charging rollers have hardness of 82° and 81°, respectively. That is, the hardness of the charging rollers is greater than 80°. Accordingly, the elasticity is reduced due to high hardness, resulting in the contact between the photoconductive medium and the charging roller in an image forming apparatus becoming uneven, thereby causing defective charging.

Additionally, in the charging rollers manufactured according to Comparative Examples 3 and 5 in which the content ratio of the epichlorohydrin rubber to the ethylene vinyl acetate copolymer is 8:2, image defects occurred in the test under high temperature/high humidity. Both the charging rollers manufactured in Comparative Examples 3 and 5 did not reach 90% of the degree of crosslinking. More particularly, since the rubber content is excessively high compared to the resin content, insufficient crosslinking occurs, causing image defects.

Therefore, the content ratio of the epichlorohydrin rubber to the ethylene vinyl acetate copolymer may desirably be about 3:7 to about 7:3.

Additionally, in the charging rollers manufactured according to Comparative Examples 3 and 5 in which the content ratio of the epichlorohydrin rubber to the ethylene vinyl acetate copolymer is 8:2, workability was poor and thus mass productivity was not desirable during tube withdrawal.

The charging roller manufactured according to Example 2 differs in crosslinking method from the charging roller manufactured according to Comparative Example 2. More specifically, in Example 2, the charging roller was manufactured through the crosslinking operation by electron beam irradiation, whereas in Comparative Example 2, the charging roller was manufactured by the crosslinking operation using the crosslinking agent. The two charging rollers have the same resistance value, a similar hardness and a similar degree of crosslinking. Accordingly, a charging roller having desirable properties in chargability and image quality under the high temperature and high humidity may be manufactured even when the crosslinking agent is not used.

In the charging rollers manufactured according to Examples 4 to 7, the content ratios of the acrylonitrile butadiene rubber to the ethylene vinyl acetate copolymer are 3:7, 5:5, 7:3 and 8:2, respectively. No defective charging and image defect were seen in the tests for defective charging and the test under high temperature/high humidity for the charging rollers.

The charging roller of Comparative Example 7 contains only the ethylene vinyl acetate copolymer, not the acrylonitrile butadiene rubber, and the charging roller of Comparative Example 8 contains 20 phr of the acrylonitrile butadiene rubber and 80 phr of the ethylene vinyl acetate copolymer. In both of these charging rollers, the resin content is greater than 80 phr. Additionally, the charging roller of Comparative Example 7 has a hardness of 96° and the charging roller of Comparative Example 8 has a hardness of 84°. That is, the hardness of the charging rollers is greater than 80°. Accordingly, the elasticity is reduced due to high hardness, and the contact between the photoconductive medium and the charging roller in an image forming apparatus becomes uneven, thereby causing defective charging.

Additionally, in the charging roller of Comparative Example 6 containing 90 phr of the acrylonitrile butadiene rubber and 10 phr of the ethylene vinyl acetate copolymer, the rubber content is excessively high compared to the resin content, and thus insufficient crosslinking occurs, causing image defects under the high temperature and high humidity conditions.

Therefore, the content ratio of the acrylonitrile butadiene rubber to the ethylene vinyl acetate copolymer is determined to desirably be about 3:7 to about 8:2.

The content ratio of the rubber to the resin can be changed according to whether an epichlorohydrin rubber or an acrylonitrile butadiene rubber is used. This is because the degree of crosslinking is determined according to components of the rubber, and because the acrylonitrile butadiene rubber has a greater number of functional groups capable of being coupled to a surface during a crosslinking reaction, as compared to the epichlorohydrin rubber.

Tests for properties were performed when the charging rollers manufactured in Examples 8 to 10 and Comparative Examples 9 and 10 contain 30 phr of the epichlorohydrin rubber and 70 phr of the ethylene vinyl acetate copolymer. In this situation, the contents of the conductive agents are different from one another.

The charging rollers manufactured in Examples 8 to 10 contain 1 phr, 5 phr and 10 phr of the conductive agents, respectively. In other words, the content of the conductive agent is greater than at least 1 phr. As a result of the tests for properties, no defective charging and image defects were seen under the high temperature and high humidity conditions.

However, defective charging occurred in both the charging roller manufactured in Comparative Example 9 in which no conductive agent is used and the charging roller manufactured in Comparative Example 10 in which 0.5 phr of the conductive agent is contained. This defective charging was caused by the high resistance value when the conductive agent is contained in an amount of 1 phr or less. Referring to Table 3, the charging rollers manufactured in Comparative Examples 9 and 10 have resistance values of 9.0×10⁹ and 9.0×10⁸, respectively, which are excessively high compared to the charging rollers manufactured in Examples 8 to 10.

While the disclosure has been particularly shown and described with reference to several embodiments thereof with particular details, it will be apparent to one of ordinary skill in the art that various changes may be made to these embodiments without departing from the principles and spirit of the invention, the scope of which is defined in the following claims and their equivalents.

What is claimed is:

1. A method of manufacturing a charging roller for an electrophotographic image forming apparatus, the method comprising:
introducing a conductive agent and a mixture of a rubber-based material and polyolefin-based resin into an extruder;
extruding the conductive agent and the mixture to obtain an extrudate;
crosslinking the extrudate by electron beam irradiation; and
polishing the crosslinked extrudate.

2. The method of claim 1, wherein the rubber-based material comprises one material selected from the group consisting of an acrylonitrile butadiene rubber, an epichlorohydrin rubber, a styrene butadiene rubber and any combination of two or more thereof, and
wherein the polyolefin-based resin comprises one material selected from the group consisting of polypropylene, polyethylene, ethylene vinyl acetate copolymer and any combination of two or more thereof.

3. The method of claim 2, wherein, when the rubber-based material is an acrylonitrile butadiene rubber, and when the polyolefin-based resin is an ethylene vinyl acetate copolymer, a content ratio of the acrylonitrile butadiene rubber to the ethylene vinyl acetate copolymer is in the range of about 3:7 to about 8:2.

4. The method of claim 2, wherein, when the rubber-based material is an epichlorohydrin rubber, and when the polyolefin-based resin is an ethylene vinyl acetate copolymer, a content ratio of the epichlorohydrin rubber to the ethylene vinyl acetate copolymer is in the range of about 3:7 to about 7:3.

5. The method of claim 1, wherein the conductive agent comprises one selected from the group consisting of a cationic surfactant such as lauryl trimethyl ammonium, stearyl trimethyl ammonium, octadodecyl trimethyl ammonium, dodecyl trimethyl ammonium, hexadecyl trimethyl ammonium, and modified fatty acid dimethyl ethyl ammonium; an anionic surfactant such as aliphatic sulfonate, higher alcohol sulfate ester salts, higher alcohol ethylene oxide-added sulfate ester salts, higher alcohol phosphate ester salts and higher alcohol ethylene oxide-added phosphate ester salts; a conductive carbon black; metal oxide such as tin oxide, titanium oxide, lithium oxide and zinc oxide; metals such as nickel, cooper, lithium, silver, and germanium; metal salts such as LiCF₃SO₃, NaClO₄, LiAsF₆, LiBF₄, NaSCN, KSCN, and NaCl; a conductive polymer such as polyaniline, polypyrrole, and polyacetal; and any combination thereof.

6. The method of claim 1, wherein the conductive agent is contained in an amount within a range from about 1 phr to about 20 phr.

7. The method of claim 1, further comprising, before the crosslinking and the polishing steps:
expanding the extrudate; and
contracting the expanded extrudate.

8. The method of claim 1, further comprising, after the polishing step:
washing the polished extrudate.

9. The method of claim 1, wherein the crosslinking comprises irradiating an electron beam onto the extrudate in a radiation shielding chamber.

10. The method of claim 1, wherein the charging roller has a single-layered structure.
